(19) United States
(12) Patent Application Publication
(10) Pub. No.: US 2005/0268280 A1
(43) Pub. Date: Dec. 1, 2005

(54) Encapsulating changes to a software application

(76) Inventor: Ulf Fildebrandt, Schwetzingen (DE)

Correspondence Address: FISH & RICHARDSON, P.C., PO BOX 1022, MINNEAPOLIS, MN, 55440-1022, US

(21) Appl. No.: 10/853,905

(22) Filed: May 26, 2004

(51) Int. Cl. G06F 9/44

(52) U.S. Cl. 717/113

(57) ABSTRACT

Described are methods and apparatus, including computer program products, for encapsulating a set of changes to a software application. A template is defined that includes a plurality of tasks to accomplish the set of changes to the software application. The template is associated with a plurality of development objects. An identification of a development object is received and one or more templates associated with the development object are identified. An identification of a selected template from the one or more templates is received and the selected template is applied to generate the development object.

### BACKGROUND

The present invention relates to software application development.

When a developer uses an integrated development environment (IDE) (e.g., Eclipse, an open source tool platform) to develop an application, the developer works according to the granularity of the tools of the IDE. Thus, when the developer wants to make a change to an application (e.g., to add a special feature), the developer typically goes through a series of steps to incorporate the special feature, the steps being defined by the granularity of the tools. The developer understands that incorporating a particular feature may require a series of tasks, and the developer is likely to follow the same series of tasks (a certain pattern) when incorporating that feature. The developer may know such a pattern because that same series of tasks is how he or she solved the problem in the past.

For example, in an application that generates a user interface (UI) for a Web-accessible data repository, assume that the developer wants to add code to have a UI element in a view trigger an exit point in the view (sometimes referred to as firing a plug). To incorporate this feature, the developer may go through the following series of tasks:
1) Create or select a UI element
2) Create or select an action
3) Create or select an event handler
4) Create or select a plug
5) Insert code fragment to fire the selected plug

In the example above, the UI element, action, event handler, and plug are all development objects (DOs). Development objects are units of an application that are defined by the developer and put together to form the application. In other words, the development objects are the building blocks of the application. The types of development objects that can be used to create an application are typically defined by an application development framework. For example, in the Web Dynpro application development framework created by SAP AG of Walldorf (Baden), Germany, applications are developed using a model-view-controller architecture, and in such an environment, development objects include information necessary to define the development object. This information can include metadata and/or code. For example, in a declarative environment, a development object has predefined attributes. To define the development object, an application developer defines a value for each of the predefined attributes. Some of the values may also be predefined, so that the developer simply selects a value from a list of the predefined values for that attribute. In one example, development objects are represented in classes in a model, where the application developer defines instances of the development objects to define an application. In the declarative environment, the model of the classes of the development objects are referred to as a metmodel, and defining the instances of the development objects involves defining metadata for the development objects. In some environments, development objects can be nested to create hierarchies—for example, the development objects listed in the example above can be children of a parent development object, such as a view development object that defines the graphical portion of the UI displayed and the navigation of that displayed UI.

In the example above, the UI element development object represents a particular UI element, such as a displayed button, that is going to be used to assist in the navigation caused by the plug. An action development object represents the task with which the UI element is going to be associated, such as entering a new customer. The event handler is a development object that performs certain tasks in response to an event, such as checking an entered value of an attribute against the attribute type to ensure that the value is a valid value. A plug is a development object that performs navigation, such as from the current screen to another screen (e.g., to a new screen with fields for a customer for the new customer action example above).

Typically, the granularity of the tools in an IDE allows a developer to create, select, and edit development objects. Operating at this level of granularity, the developer deals with each development object individually. So for the first task in the example above, the developer uses a tool that allows the developer to create or select a UI element. For the second task, the developer uses a tool that allows the developer to create or select an action. This process is repeated for each of the steps. The developer learns and memorizes the steps above that accomplish the goal of the scenario to add the desired feature, by working with each of the affected development objects.

### SUMMARY OF THE INVENTION

The description describes methods and apparatus, including computer program products, for a framework for encapsulating a set of changes to a software application. For example, the framework encapsulates the steps of the scenario using a single template that is associated with each of the applicable development objects, and that can be selected by the developer to repeat the steps of the scenario in an automated fashion.

In general, in one aspect, there is a computer program product, tangibly embodied in an information carrier, for encapsulating a set of changes to a software application. The computer program product includes instructions being operable to cause data processing apparatus to define a template that includes a plurality of tasks to accomplish a set of changes to a software application and associate the template with a plurality of development objects.

In another aspect, there is a system for encapsulating a set of changes to a software application. The system includes a computing device that is configured to define a template that includes a plurality of tasks to accomplish the set of changes to the software application and associate the template with a plurality of development objects.

In another aspect, there is a method for encapsulating a set of changes to a software application. The method includes defining a template that includes a plurality of tasks to accomplish the set of changes to the software application and associating the template with a plurality of development objects.

In other examples, any of the aspects above can include one or more of the following features. The template can include a wizard portion and a generation portion. The wizard portion can include a wizard class. The wizard portion can include an applicable class and a data class. The generation portion can include a generation class. The template can be associated with a plurality of wizard pages corresponding to the plurality of tasks. At least a portion of the template can correspond to changes associated with metadata of one of the development objects. At least a portion of the template can correspond to changes associated with a fragment of source code associated with one of the development objects. The template can be defined using an extended markup language.

In another aspect, there is a computer program product, tangibly embodied in an information carrier, for applying an encapsulated set of changes to a software application. The computer program product includes instructions being operable to cause data processing apparatus to receive an identification of a development object and to identify one or more templates associated with the development object, each template comprising a plurality of tasks to accomplish a set of changes to a software application. The computer program product also includes instructions being operable to cause data processing apparatus to receive an identification of a selected template from the one or more templates and apply the selected template to generate the development object.

In another aspect, there is a system for encapsulating a set of changes to a software application. The system includes a computing device configured to receive an identification of a development object and identify one or more templates associated with the development object, each template comprising a plurality of tasks to accomplish a set of changes to a software application. The computing device is also configured to receive an identification of a selected template from the one or more templates and apply the selected template to generate the development object.

In another aspect, there is a method for encapsulating a set of changes to a software application. The method includes receiving an identification of a development object and identifying one or more templates associated with the development object, each template comprising a plurality of tasks to accomplish a set of changes to a software application. The method also includes receiving an identification of a selected template from the one or more templates and applying the selected template to generate the development object.

In other examples, any of the aspects above can include one or more of the following features. The one or more additional development objects can be generated by applying the selected template. A data object corresponding to the selected template can be generated. Data can be assigned to the data object based on a user input. Source code can be generated based on the data object. Wizard pages can be displayed to a user to obtain a user input. A user can be enabled to select the selected template. The user can be presented with a list including the selected template. The selected template can be associated with a user coding area of the development object. An identifier can be generated for a source code fragment generated by a user in the user coding area of the development object. A source code fragment generated by a user can be inserted in the user coding area of the development object. A source code fragment generated by a user can be inserted in generated source code corresponding to the user coding area. An instance of the selected template can be generated based on a user input. In some examples, the instance of the selected template is not a typed object.

Values of the instance of the selected template can be reapplied to the development object. A user can be enabled to edit a first one of the values of the instance of the selected template before the first one of the values is reapplied. The instance of the selected template can be associated with the development object. The instance of the selected template can be associated with the development object using a template marker.

Implementations can realize one or more of the following advantages. The use of a template enables the encapsulation of multiple changes or tasks, thereby allowing developers to work at a higher level of granularity. A template can be associated with and applied across multiple development objects. The template can be applied to both application metadata and source code. A list of applicable templates can be identified for a development object, and a developer can select and apply a desired template from the list of templates. Each application of a template can be saved as a template instance. A template can be reapplied by identifying an instance of the template (i.e., an earlier application of the template) and reusing the values specified as part of the earlier application of the template. In this manner, small changes can be made by modifying values and reapplying templates, rather than by deleting and recreating development objects through the new application of templates. One implementation of the invention provides all of the above advantages.

The details of one or more examples are set forth in the accompanying drawings and the description below. Further features, aspects, and advantages of the invention will become apparent from the description, the drawings, and the claims.

### BRIEF DESCRIPTION OF THE DRAWINGS

FIG. 1 is a block diagram of a system for encapsulating a set of changes to a software application in a template.

FIG. 2 is a block diagram of a process for using templates.

FIG. 3 is a screen shot of an example wizard page for using templates.

FIG. 4 is a screen shot of another example wizard page for using templates.

FIG. 5 is a block diagram of another process for using templates.

FIG. 6 is a Unified Modeling Language (UML) diagram of classes that can be used to represent template instances and to associate template instances with development objects.

### DETAILED DESCRIPTION

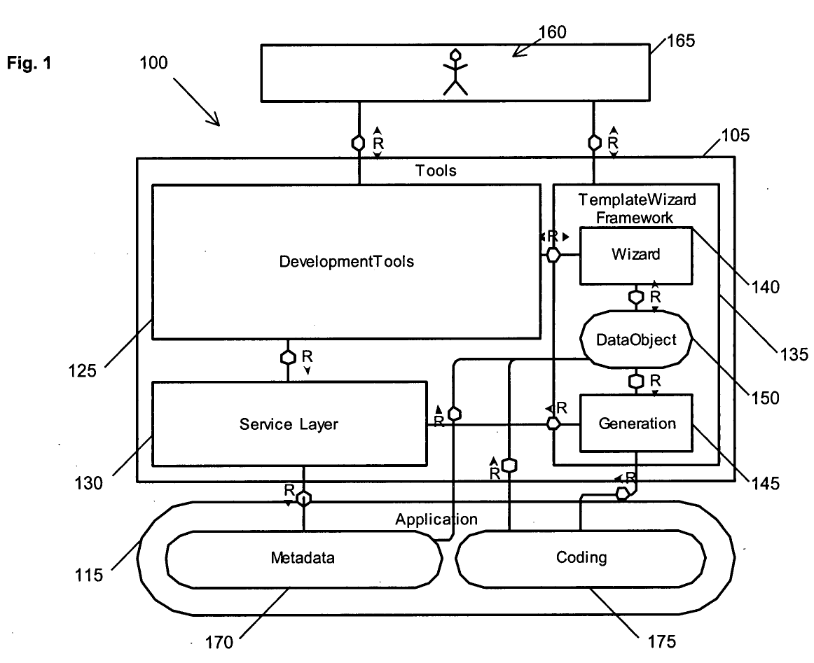

FIG. 1 illustrates a system 100 that can be used to develop and change software applications. To accomplish these tasks, the system 100 includes a development client 105, which communicates with a repository 115. The development client 105 includes development tools 125, a service layer 130, and a template wizard framework 135. The template wizard framework 135 in FIG. 1 includes a wizard module 140, a generation module 145, and a data object repository 150. In operation, an application developer 160 (e.g., using a computing device 165) uses the development client 105 to develop and change an application (for example, a Web user interface application). The application developer 160 uses the applicable development tools 125 to create and modify elements (e.g., development objects) of the user interface application. The service layer 130 serves as an interface to the repository 115 for the tools 125 and the template wizard framework 135. For example, the service layer 130 can include an application program interface (API) that enables the tools 125 and the template wizard framework 135 to create development objects and store/access the development objects in repository 115.

In one example, the system 100 is a system that uses a declarative approach to application development. An advantage of a declarative approach is that the application developer 160 does not generally need to generate source code to develop an application. Instead, the application developer 160 develops the application using a highly declarative programming model that uses metadata (e.g., stored in the metadata repository 170) to define the elements (e.g., development objects) of the application. In such an example, instead of writing program code, the application developer 160 creates development objects and defines relations between these development objects. The development objects in this example are declarative building blocks that the development client 105 manages. Moreover, development object content in this example is called metadata. In other words, the application developer 160 composes development objects in a declarative manner, using metadata, rather than writing code to generate an application.

Continuing with this example, the system 100 can be used to develop UI applications. Some example development objects for a user interface application include UI elements (e.g., screen controls such as buttons and input fields), views (e.g., displays with layouts of UI elements), data bindings (e.g., bindings between UI elements and application data), inbound and outbound plugs as start- and end-points for navigational links between the views, and the like. After the application developer 160 has declared data to define these development objects, and the system 100 has stored this metadata in the metadata repository 170, a generator (not shown) generates source code to implement the development objects for a particular platform on which the development objects will execute. The generated source code is stored in the coding repository 175.

Typically, the declarative development objects defined by the declarative environment cannot accommodate all conceivable application scenarios. To account for this and make the environment flexible, the declarative environment can include a way to insert source code written by the application developer 160 into the development objects. For example, one or more of the development objects can include a user coding area (UCA) for the insertion of a source code fragment written by the application developer 160. In the example scenario above, a plug development object includes a UCA so that the application developer 160 can insert code to fire the plug. For example, in a particular view, the application developer 160 may want to require a specific action to navigate to another view. The specific action may be an action not generically available by predefined actions from which the application developer 160 can select. The application developer 160 writes his own code to trigger an exit point (fire a plug). The exit point is, for example, the navigation link to cause the view to change to another view, defined by the particular plug used.

During the course of application development, a developer may wish to modify an application, e.g., by changing an existing feature or adding a new feature. Such changes may require modifications to one or more existing development objects and their corresponding metadata, as well as to source code fragments in the application. Such changes may also require the creation of new development objects or source code fragments. The system 100 can use templates to encapsulate such changes, so that the changes can be repeated with reference to other (or to the same) development objects and source code fragments.

More specifically, the template wizard framework 135 can encapsulate changes to both the metadata defining the development objects (the declarative portion) as well as changes to any source code fragments written by the application developer 160. To encapsulate such changes, the template wizard framework 135 uses a template. The template represents the set of set of tasks needed to accomplish a modification (e.g., the incorporation of a feature). For example, as explained previously, if an application developer 160 wants to add code to fire a plug used in a UI element, the developer 160 may go through the following series of tasks:
1) Create or select a UI element
2) Create or select an action
3) Create or select an event handler
4) Create or select a plug
5) Insert code fragment to fire the plug

Thus, a template to incorporate this modification manages each of these tasks so that the complete modification can be achieved without the need for the application developer 160 to have to memorize these steps and/or work with each of the development objects individually. For illustrative purposes, this template will be referred to as the Action Button template.

The template wizard framework 135 allows the application developer 160 to use the template in different ways. In one way, the application developer 160 is able to “apply” the template to complete the specified tasks. In one implementation, applying a template creates an instance of the template.

In other words, the particular inputs and data the application developer 160 uses for that template are stored as the instance of the template. In another way, the application developer 160 is able to “reapply” a particular instance of a template. As described in more detail below, when the application developer 160 applies a template, the wizard framework 135 generates wizard pages using the template, with its tasks, to gather the data needed for those tasks. The wizard framework 135 uses the repository 150 to create a data object, and fills the data object with the data as the wizard pages obtain the data from the application developer 160. Once the data collection is complete, the template wizard 135 can generate a template instance (e.g., a particular instance of the template (set of tasks) with the particular data entered for that one application of the template).

When the application developer 160 reapplies a template instance, the wizard framework 135, instead of obtaining data from the application developer 150 using wizard pages, obtains directly from repository 115 the data that is stored as a template instance. The wizard framework 135 takes the data from the template instance and uses that data to create a data object. The template wizard 135 can generate another template instance using the data in the data object. In general, reapplying a template can refer to (i) applying the same set of changes to a different DO or set of DOs, and (ii) modifying a few values or changes in a previous application of the template for a particular DO or set of DOs (rather than deleting the DOs and applying the template from scratch).

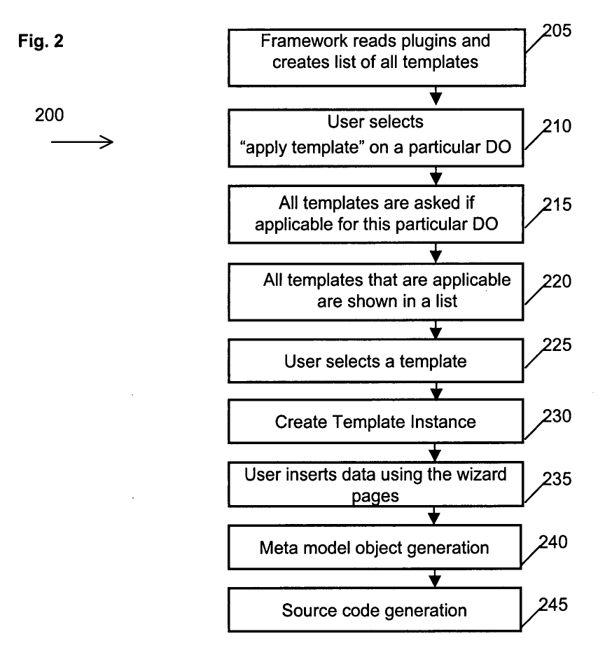

FIG. 2 illustrates process 200 to apply a template. The template wizard framework 135 reads (205) plugins and creates (205) a list of all templates. In general, plugins are additional files that are defined so that the framework retrieves those files and uses them in processing. A plugin associated with the templates is a file that lists the templates available for that plugin. As an illustrative example, the code below represents a portion of an extended markup language (XML) file of a plugin (to simplify the example, some of the imported plugins are omitted).

```
<?xml version=“1.0” encoding=“UTF-8” ?>
- <plugin id=“com.sap.ide.webdynpro.template.simplescenario” name=“%plugin.name”
version=“2.0.0” provider-name=“SAP AG”
class=“com.sap.ide.webdynpro.template.simplescenario.plugin.
SimpleScenarioTemplatesPlugin”>
  - <runtime>
      - <library name=“SAPIdeWDTemplatesSimpleScenario.jar”>
          <export name=“*” />
        </library>
    </runtime>
  - <requires>
        <import plugin=“org.eclipse.core.boot” />
        <import plugin=“org.eclipse.core.resources” />
                .
                :
        <import plugin=“com.sap.ide.tools.core.template” />
        <import plugin=“com.sap.ide.tools.core.template.service” />
        <import plugin=“com.sap.ide.webdynpro.template.simplescenario.generation” />
        <import plugin=“com.sap.dictionary.designtime” />
    </requires>
- <extension point=“com.sap.ide.tools.core.template.TemplateWizard”>
    <template name=“Action Button” applicableClass=“com.sap.ide.webdynpro.template.
        simplescenario.actionbutton.NavigationApplicable”
        wizardClass=“com.sap.ide.webdynpro.template.simplescenario.actionbutton.
        NavigationWizard”
        dataClass=“com.sap.ide.webdynpro.template.simplescenario.actionbutton.
        NavigationData” id=“com.sap.ide.webdynpro.template.actionbutton”
        type=“WebDynpro” singleton=“false” nature=“Generation”
        iconLarge=“/com.sap.ide.webdynpro.template.simplescenario/resources/
        navigation.gif” />
    <template name=“Service Controller” applicableClass=“com.sap.ide.webdynpro.
      template.simplescenario.servicecontroller.ModelApplicable”
      wizardClass=“com.sap.ide.webdynpro.template.simplescenario.servicecontroller.
      ModelWizard”
      dataClass=“com.sap.ide.webdynpro.template.simplescenario.servicecontroller.
      ModelData” id=“com.sap.ide.webdynpro.template.servicecontroller”
      type=“WebDynpro” singleton=“false” nature=“Generation”
      iconLarge=“/com.sap.ide.webdynpro.template.simplescenario/resources/
      navigation.gif” />
  </extension>
</plugin>
```

This example XML plugin lists two available templates named Action Button and Service Controller. The XML plugin identifies for each template the classes (e.g., JAVA classes) that the template wizard framework 135 employs to use the particular template. The XML plugin defines an applicable class, a wizard class, and a data class for each template. The applicable class determines which development objects are associated with this template. The applicable class includes code so that the template wizard framework 135 can query a development object to determine if the template is associated with that development object. The wizard class determines which wizard pages are associated with this template. The wizard class includes code so that the template wizard framework 135 can generate the appropriate wizard pages. The data class determines which data are needed for this template. The data class includes code so that the template wizard framework 135 can generate the appropriate wizard pages to obtain the needed data.

Referring to FIG. 2, the application developer selects (210), e.g. from a menu, to “apply” a template to a particular development object. The particular development object is one on which the application developer 160 wants to incorporate the changes represented by the template. For example, in the above scenario the Action Button template includes the tasks to add code to add an action button to fire a plug. All of the development objects of the tasks (i.e., a UI element, an action, an event handler, and a plug) are child development objects of a view development object. So for an illustrative example, the particular development object can be an instance of a view development object, named View1, to which the application developer 160 wants to add code to add an action button to fire a plug.

Continuing with process 200, the template wizard framework 135 determines (215) if the selected template is applicable for the particular development object (e.g., View1). A template is applicable for a development object if the template is used to help define all or a portion of that development object—e.g., if the template is used to define an attribute of the development object. For example, in the scenario above, the Action Button template is used to define attributes for the development objects UI element, action, event handler, and plug, as well as the parent development object of these development objects, namely a view development object.

As described above, in one example the template wizard framework 135 uses the applicable class identified for each of the templates to query the particular development object. So using the above example XML file, the template wizard framework 135 uses the identified applicable class “com.sap.ide.webdynpro.template.simplescenario.actionbutton. NavigationApplicable” to determine if the template Action Button is applicable to the development object View1. If the template is applicable, the template wizard framework 135 displays (220) the Action Button template in a list of applicable templates. Similarly, the template wizard framework 135 uses the identified applicable class “com.sap.ide.webdynpro.template.simplescenario.servicecontroller.ModelApplicable” to determine if the template Service Controller is applicable to the development object View1. If the template is applicable, the template wizard framework 135 displays (220) the Service Controller template in a list of applicable templates.

With a list of applicable templates displayed, the application developer 160 can select (225) the template that he wants to apply to the development object. If the application developer 160 wants to add an action button to View1, then the application developer 160 selects (225) the Action Button template. In one implementation, when the Action Button template is used, the template wizard framework 135 creates (230) a template instance for the Action Button template. A template instance is a particular instance of a template that stores the data entered by the application developer 160 during the data collection process. To collect the data, the template wizard framework 135 can generate wizard pages that enable the application developer 160 to select and/or enter (235) requested data.

As described above, in one example the template wizard framework 135 uses the wizard class and the data class identified for the Action Button template to generate wizard pages. So using the above example XML file, the template wizard framework 135 uses the identified wizard class “com.sap.ide.webdynpro.template.simplescenario.actionbutton. NavigationWizard” and the identified data class “com.sap.ide.webdynpro.template. simplescenario.actionbutton.NavigationData” to generate the wizard pages and collect data for the Action Button template. Using the example scenario above, the wizard pages associated with the Action Button template steps the application developer 160 through the tasks of creating or selecting a UI element, creating or selecting an action, creating or selecting an event handler, creating or selecting a plug, and obtaining a code fragment to fire the plug. For example, in creating a UI element (in this example a button), the wizard pages can ask for the type of button (e.g., round, square), the name for the UI element, and any text that the application developer 160 wants displayed on the button.

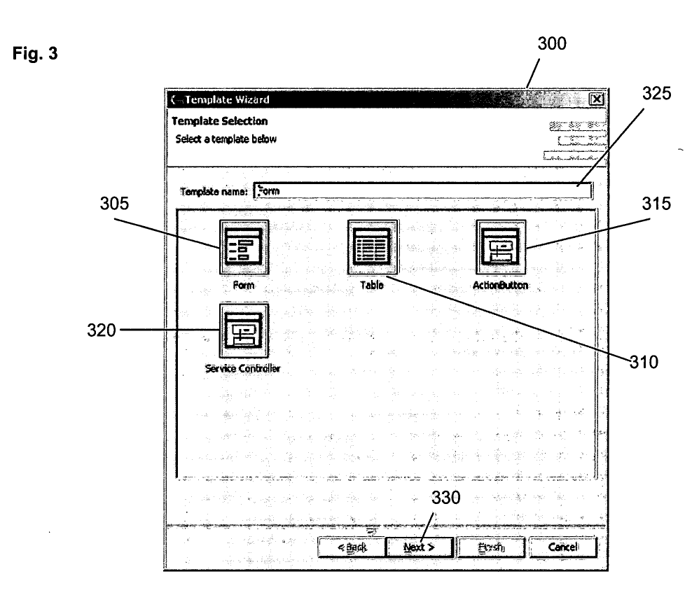

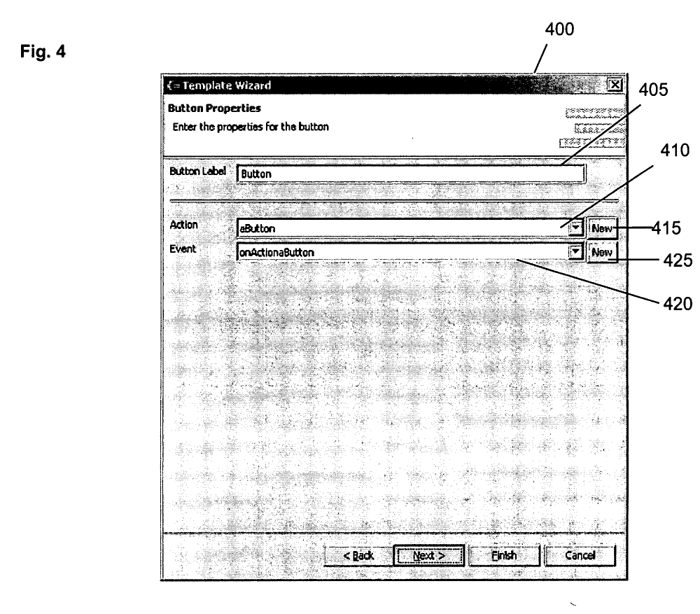

FIGS. 3 and 4 illustrate example wizard pages 300 and 400 the template wizard framework 135 can generate. Referring to FIG. 3, the wizard page 300 illustrates an example wizard page for enabling the user to select an available template. Wizard page 300 includes selection buttons 305, 310, 315, and 320 to enable the user to select a form template, a table template, an action button template, and a service controller template, respectively. The user can assign a name to the template instance he is generating by typing a name into the text entry box 325. When a template has been selected, the user can click on the next button 330 to go to another wizard page.

Referring to FIG. 4, the wizard page 400 illustrates an example wizard page for enabling the user to create or select an action and an event associated with an instance of a button template. Wizard page 400 includes a text entry box 405 to provide a label for the button that will be generated. Wizard page 400 includes a drop down menu 410 to select an existing action to be associated with the generated button. If the user does not want to use an existing action, the user can select the new button 415, to enable the user to define a new action to be associated with the generated button. Similarly, wizard page 400 includes a drop down menu 420 to select an existing event to be associated with the generated button. If the user does not want to use an existing event, the user can select the new button 425, to enable the user to define a new action to be associated with the generated button.

As described above, as the application developer 160 enters data to define these development objects (e.g., UI element, action, event handler, plug) for the template, the template wizard framework 135 can save this data (e.g., temporarily, until code generation) using repository 150. For example, the data for a square button named Buttonl with the text “GO” displayed on the button are stored in repository 150 as the application developer 160 completes those wizard pages and proceeds to complete the other tasks of the template.

When the template wizard framework 135 has collected all of the needed data, the template wizard framework 135 can generate (240 and 245) the appropriate metadata for the development objects and the source code. In one example, to perform the generation tasks (240 and 245), the template wizard framework 135 uses a generation portion of a template. For example, the XML file above was used to define the classes needed to determine the applicability of a template, the wizard pages associated with the template, and the data needed to create a template instance. In this example XML file, the template wizard framework 135 reads another plugin defining the generation portion of the template. The plugin is defined in the code portion “<import plugin=“com.sap.ide.webdynpro.template.simplescenario.generation”/>”. As an illustrative example, the code below represents a portion of an extended markup language (XML) file of a plugin defining the generation portion of the template (to simplify the example, some of the imported plugins are omitted).

```
<?xml version=“1.0” encoding=“UTF-8” ?>
- <plugin id=“com.sap.ide.webdynpro.template.simplescenario.generation”
name=“%plugin.name” provider-name=“SAP AG” version=“2.0.0”>
  - <runtime>
      - <library name=“SAPIdeWDTemplatesSimpleScenarioGen.jar”>
            <export name=“*” />
        </library>
    </runtime>
  - <requires>
        <import plugin=“com.sap.ide.metamodel.common.libs” />
        <import plugin=“com.sap.ide.metamodel.core” />
                  .
                  .
                  .
        <import plugin=“com.sap.ide.tools.core.template” />
        <import plugin=“com.sap.ide.tools.core.template.service” />
    </requires>
  - <extension point=“com.sap.ide.tools.core.template.TemplateGeneration”>
          <template name=“ActionButton Generation”
              generationClass=“com.sap.ide.webdynpro.template.simplescenario.generation.
              actionbutton.NavigationGeneration”
              id=“com.sap.ide.webdynpro.template.actionbutton” />
          <template name=“ServiceController Generation”
              generationClass=“com.sap.ide.webdynpro.template.simplescenario.generation.
              servicecontroller.ModelGeneration”
              id=“com.sap.ide.webdynpro.template.servicecontroller” />
    </extension>
    </plugin>
```

This example XML plugin lists the generation portion for the two available templates named Action Button and Service Controller. The XML plugin identifies for each template the classes (e.g., JAVA classes) that the template wizard framework 135 employs to use the particular template during the generation process (240 and 245). The XML plugin defines a generation class for each template. The generation class includes code that enables the template wizard framework 135 to generate the development objects and/or changes based on the data entered by the application developer 160, and associate the template instance with the development objects and source code (e.g., store the metadata and/or template code portions in the development objects and/or source code as applicable).

In one example, the template wizard framework 135, using generation module 145, performs the generation process in two separate steps. In the first step, the template wizard framework 135 generates the metamodel objects (e.g., the instances of the development objects created using the wizard pages) and stores the created metamodel objects in repository 115 (e.g., using the service layer 130). In generating the metamodel objects, the template wizard framework 135 includes a template instance as part of the metamodel object. In the second step, the template wizard framework 135 inserts the code fragments generated by the application developer 160 into the UCA of the development objects and into the source code generated for those development objects. The template wizard framework 135 can omit the second step when there is no code fragment involved with a particular template.

When handling a code fragment, the template wizard framework 135 can generate an identifier (ID) for the code fragment. In one example, the template wizard framework 135 generates an ID by concatenating the name of the template instance and a hashcode of the generated coding fragment. By using a hashcode, the template wizard framework 135 can determine whether there has been a change to the source code. Once scenario where such a feature is used is in an upgrade scenario, where it might be desirable to update the sources. For example, a user may have applied a template in release A and now a new template with extended functionality is delivered in release B. In this new release, the template wizard framework 135 detects that there are no changes in the source, meaning that the user agrees with the functionality that was provided with the original template and does not need to use the extended functionality of the new template. However, when the user now reapplies the new template, the old coding is replaced with the new coding, since the new coding may have better performance capabilities, etc.

The following code is an example of a direct call used to insert the code fragments into the source code associated with the applicable development objects.

```
//@@begin onActionTest(ServerEvent)
    //$$begin <templateinstancename>(<hashcode of content>)
        wdThis.wdFirePlug<plugname>( );
    //$$end
//@@end
```

In an implementation where the template framework uses template instances, once a template has been applied (e.g., the application developer 160 enters all the needed data using the wizard pages) and a template instance has been generated and stored in the metadata and source code, the template instance is available to be reapplied by the application developer 160 or others accessing the instances of the development objects with which the template instance is associated.

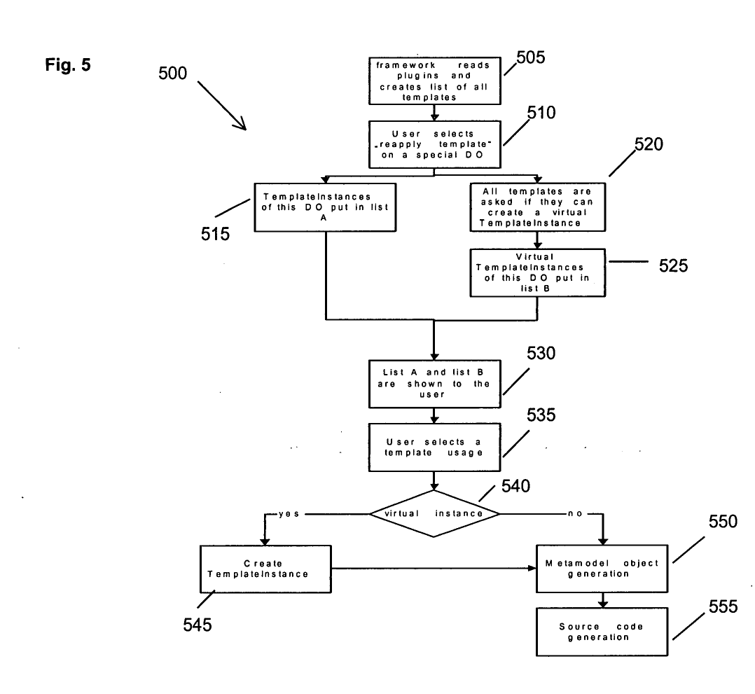

FIG. 5 illustrates an example process 500 that reapplies a template instance. As in the process 200, the template wizard framework 135 reads (505) the plugins to determine the templates that are available. In process 500, the application developer 160 selects (510) to “reapply” a template on a particular development object (unlike in process 200, where the application developer 160 selected (210) to “apply” a template). To determine which template instances are available to the application developer 160, the template wizard framework 135 follows two parallel paths. On the first path, the template wizard framework 135 queries (515) the development objects to determine whether there are any template instances for this development object. As described above, during the generation process, the template instance is added to the development objects. The development objects are stored together as a metamodel. A metamodel is a semantic information model that shows the classes available in that model and the relationships between the classes. In the example framework, the metamodel can be queried. If any template instances exist, the metamodel responds to the query by listing all template instances found in the metamodel for the particular development object.

On the second path, the template wizard framework 135 determines whether, in the event no actual template instance exists, a virtual template instance can be generated. To make this determination, the template wizard framework 135 can query the templates that are available to this particular development object to ask if they can create a virtual template instance. To determine whether a virtual template instance can be created, the template must determine whether the needed data exists in the applicable development objects.

For an illustrative example, the template Action Button manages the five tasks of the example scenario provided above, which are the tasks of creating or selecting a UI element, creating or selecting an action, creating or selecting an event handler, creating or selecting a plug, and obtaining a code fragment to fire the plug. In order to create a virtual template instance, the data needed to complete each task has to be defined for the corresponding development objects. For example, when creating the UI element button in an example above, the application developer 160 defined data for the type of button, the name of the button, and the text to be displayed on the button. There could be a case where the application developer 160 performed each of these tasks manually (i.e., without using a template) so that the tasks were all completed, but there is no corresponding template instance because the application developer did not use a template. When the template Action Button queries the development objects, the template may determine that the needed data does exist. In that case, the template can respond to the template wizard framework 135 that a virtual template instance is available, and the template wizard framework 135 can add (525) the virtual template instance to the list of available template instances.

The template wizard framework 135 displays (530) to the application developer 160 a list of all of the available template instances, which may include actual template instances stored in a metamodel, as well as virtual template instances. The template wizard framework 135 enables (535) the application developer 160 to select a template instance from the list of available template instances to reapply. Upon selection (535) from the application developer 160, the template wizard framework 135 determines (540) whether the selected template instance is a virtual template instance. If the template instance is a virtual instance, the template wizard framework 135 creates (545) an actual template instance using the data identified for the virtual template instance.

As an example, referring back to the virtual template instance above, if the user selected a virtual Action Button template instance, the template wizard framework 135 creates (545) an actual template instance based on the data in the applicable development objects. If, when creating the UI element button in the example above, the application developer 160 defined data for the type of button, the name of the button, and the text to be displayed on the button, this data is used by the template wizard framework to create the template instance. Once all of the data is collected, the template instance is complete. Described another way, and referring back to FIG. 1, when reapplying a template instance, the template wizard framework 135 can create a data object by obtaining the data directly from the repository 115. When using a virtual template instance, a template instance does not exist in repository 115, but the data needed to create a template instance exists in repository 115, so the template wizard framework 135 can create a data object by obtaining the appropriate data from repository 115.

Similar to the examples described above, once a data object has been created, the template wizard framework 135 can generate (550 and 555) the appropriate metamodel objects and source code corresponding to the selected template.

An example of where the application developer 160 may reapply a template instance is where he has created an action button for an instance of a view development object named View1. The application developer may now want to create the same button for another instance of a view development object named View2. By reapplying the template instance for the action button for View1, the template wizard framework 135 uses the same data to create another action button with the same data for View2.

Another way an application developer 160 can use the reapply functionality is to make a change to a particular template instance (i.e., to a previous application of a template). For example, the application developer 160 may have applied the Action Button template to create an action button for an instance of a view development object named View1, but subsequently wants to define a different action development object for that template instance. In this case, application developer 160 can select to reapply a template instance, and select the particular template instance he wants to change so that that template instance is loaded into the data object repository 150. Before generating (550 and 555) the development objects and source code corresponding to the template, however, the application developer 160 can select to edit the data values in the data object repository 150. The template wizard framework 135 can generate wizard pages to enable the application developer 160 to edit the data of the template instance. Although the example describes generation, reapplication of a template instance can be accomplished by generating a development object, regenerating a development object, or modifying values in the previously-generated development object.

As an illustrative example, the code below represents a portion of an XML file defining an instance of an action button template (to simplify the example, only some of the attributes are listed).

```
<?xml version=“1.0” encoding=“UTF-8” ?>
<EmbeddedTemplateInstance name=“ActionButton”>
    <TemplateInstance.TemplateMarkers>
        <TemplateMarker name=“ELEMENT_Button” role=“inputelement”>
            <TemplateMarker.Participant>
                <Core.ForeignReference modelName=“WebDynpro”
package=“com.sap.tc.webdynpro.tests.d029921.timed” name=“MainView” type=“View”
path=“RootUIElementContainer/Child:Button”/>
            </TemplateMarker.Participant>
        </TemplateMarker>
        <TemplateMarker name=“ACTION_Button” role=“actionhandler”>
            <TemplateMarker.Participant>
                <Core.ForeignReference modelName=“WebDynpro”
package=“com.sap.tc.webdynpro.tests.d029921.timed” name=“MainView”
type=“Controller” path=“Action:aButton”/>
            </TemplateMarker.Participant>
        </TemplateMarker>
        <TemplateMarker name=“EVENTHANDLER_Button” role=“eventhandler”>
            <TemplateMarker.Participant>
                <Core.ForeignReference modelName=“WebDynpro”
package=“com.sap.tc.webdynpro.tests.d029921.timed” name=“MainView”
type=“Controller” path=“EventHandler:onActionaButton”/>
            </TemplateMarker.Participant>
        </TemplateMarker>
        <TemplateMarker name=“FIREPLUG_Button” role=“fireplug”>
            <TemplateMarker.Participant>
                <Core.ForeignReference modelName=“WebDynpro”
package=“com.sap.tc.webdynpro.tests.d029921.timed” name=“MainView” type=“View”
path=“OutboundPlug:oPlug”/>
            </TemplateMarker.Participant>
        </TemplateMarker>
    </TemplateInstance.TemplateMarkers>
</EmbeddedTemplateInstance>
```

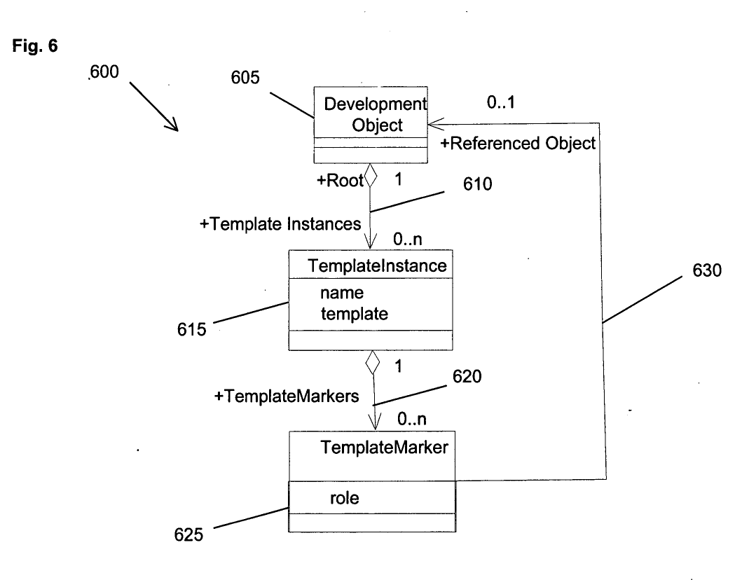

FIG. 6 illustrates a class diagram 600 of a portion of a metamodel with template instances and development objects. The class diagram 600 is represented using a unified modeling language (UML) class diagram. The specifications for UML, which are set forth by the Object Management Group (OMG), can be found on OMG's web site at http://www.omg.org/uml/. The class diagram 600 includes a development object class 605 that serves as the root of an aggregation relationship 610 with a template instance class 615. The aggregation relationship 610 has a multiplicity of one instance of the development object class 605 to zero or more instances of the template instance class 615. The template instance class 615 has an aggregation relationship 620 with a template marker class 625. The aggregation relationship 620 has a multiplicity of one instance of the template instance class 615 to zero or more instances of the template marker class 625. The template marker class 625 has an association relationship with the development object class 605. The association relationship 630 has a multiplicity of one instance of the template marker class 625 to zero or one instance of the development object class 605.

These relationships indicate that every DO can have an aggregation of zero or more template instances (i.e., template instances that are applicable to that DO). Moreover, every template instance can be associated with multiple DOs, as shown by the aggregation of the TemplateMarker class objects, which refer to DOs via the relationship 630.

Using the example scenario above, a view development object might serve as the root development object. Any template instances that are associated with a view development object are identified via the aggregation relationship 610. For each template instance that exists, there is an aggregation of template markers that identify each of the development objects (e.g., child development objects) that are associated with that template instance. In the example scenario, the UI element, action, event handler, and plug development objects can be identified via the association 630. When a metamodel is queried, relationship 610 indicates that templates exist for a specific development object. For example, if the developer 160 wants to work with a view development object, the metamodel can be queried to return the end points of relationship 610 for a view development object, which are the available template instances.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. The following are examples for illustration only and not to limit the alternatives in any way. The steps of the invention can be performed in a different order and still achieve desirable results.

1. A computer program product, tangibly embodied in an information carrier, for encapsulating a set of changes to a software application, the computer program product including instructions being operable to cause data processing apparatus to:
define a template that includes a plurality of tasks to accomplish a set of changes to a software application; and
associate the template with a plurality of development objects.

2. The computer program product of claim 1, wherein the template comprises a wizard portion and a generation portion.

3. The computer program product of claim 2, wherein the wizard portion comprises a wizard class.

4. The computer program product of claim 2, wherein the wizard portion comprises an applicable class and a data class.

5. The computer program product of claim 2, wherein the generation portion comprises a generation class.

6. The computer program product of claim 1, further comprising instructions operable to cause the data processing apparatus to associate the template with a plurality of wizard pages corresponding to the plurality of tasks.

7. The computer program product of claim 1, wherein at least a portion of the template corresponds to changes associated with metadata of one of the development objects.

8. The computer program product of claim 1, wherein at least a portion of the template corresponds to changes associated with a fragment of source code associated with one of the development objects.

9. The computer program product of claim 1, wherein the template is defined using an extended markup language.

10. A system for encapsulating a set of changes to a software application, the system comprising a computing device configured to:
define a template that includes a plurality of tasks to accomplish the set of changes to the software application; and
associate the template with a plurality of development objects.

11. A computer-implemented method for encapsulating a set of changes to a software application, the method comprising:
defining a template that includes a plurality of tasks to accomplish the set of changes to the software application; and
associating the template with a plurality of development objects.

12. A computer program product, tangibly embodied in an information carrier, for applying an encapsulated set of changes to a software application, the computer program product including instructions being operable to cause data processing apparatus to:
receive an identification of a development object;
identify one or more templates associated with the development object, each template comprising a plurality of tasks to accomplish a set of changes to a software application;
receive an identification of a selected template from the one or more templates; and
apply the selected template to generate the development object.

13. The computer program product of claim 12, further comprising instructions operable to cause the data processing apparatus to generate one or more additional development objects by applying the selected template.

14. The computer program product of claim 12, further comprising instructions operable to cause the data processing apparatus to:
generate a data object corresponding to the selected template; and
assign data to the data object based on a user input.

15. The computer program product of claim 14, further comprising instructions operable to cause the data processing apparatus to generate source code based on the data object.

16. The computer program product of claim 12, further comprising instructions operable to cause the data processing apparatus to display wizard pages to a user to obtain a user input.

17. The computer program product of claim 12, further comprising instructions operable to cause the data processing apparatus to enable a user to select the selected template.

18. The computer program product of claim 17, wherein instructions to enable a user to select the selected template comprise instructions operable to cause the data processing apparatus to present to a user a list including the selected template.

19. The computer program product of claim 12, further comprising instructions operable to cause the data processing apparatus to associate the selected template with a user coding area of the development object.

20. The computer program product of claim 19, further comprising instructions operable to cause the data processing apparatus to generate an identifier for a source code fragment generated by a user in the user coding area of the development object.

21. The computer program product of claim 19, further comprising instructions operable to cause the data processing apparatus to insert a source code fragment generated by a user in the user coding area of the development object.

22. The computer program product of claim 19, further comprising instructions operable to cause the data processing apparatus to insert a source code fragment generated by a user in generated source code corresponding to the user coding area.

23. The computer program product of claim 12, further comprising instructions operable to cause the data processing apparatus to generate an instance of the selected template based on a user input.

24. The computer program product of claim 12, wherein the instance of the selected template is not a typed object.

25. The computer program product of claim 12, further comprising instructions operable to cause the data processing apparatus to reapply values of the instance of the selected template to the development object.

26. The computer program product of claim 25, further comprising instructions operable to cause the data processing apparatus to enable a user to edit a first one of the values of the instance of the selected template before the first one of the values is reapplied.

27. The computer program product of claim 12, further comprising instructions operable to cause the data processing apparatus to associate the instance of the selected template with the development object.

28. The computer program product of claim 12, further comprising instructions operable to cause the data processing apparatus to associate the instance of the selected template with the development object using a template marker.

29. A system for encapsulating a set of changes to a software application, the system comprising a computing device configured to:
receive an identification of a development object;
identify one or more templates associated with the development object, each template comprising a plurality of tasks to accomplish a set of changes to a software application;
receive an identification of a selected template from the one or more templates; and
apply the selected template to generate the development object.

30. A computer-implemented method for encapsulating a set of changes to a software application, the method comprising:
receiving an identification of a development object;
identifying one or more templates associated with the development object, each template comprising a plurality of tasks to accomplish a set of changes to a software application;
receiving an identification of a selected template from the one or more templates; and
applying the selected template to generate the development object.
